(19) United States
(12) Patent Application Publication
(10) Pub. No.: US 2004/0069156 A1
(43) Pub. Date: Apr. 15, 2004

(54) Apparatus for forming a row

(76) Inventors: John Nicholas Reed, Bedfordshire (GB); Simon John Miles, Bedfordshire (GB); Andrew Wakefield, Swindon (GB)

Correspondence Address: KING & SCHICKLI, PLLC, 247 NORTH BROADWAY, LEXINGTON, KY, 40507, US

(21) Appl. No.: 10/617,457

(22) Filed: Jul. 11, 2003

(30) Foreign Application Priority Data
Jul. 13, 2002 (GB) 0216295.6

(51) Int. Cl. A21C 15/00; B65G 47/26

(52) U.S. Cl. 99/450.1; 198/418.5; 198/418.6; 198/427; 198/431

(57) ABSTRACT

This invention relates to apparatus of forming a row of sliced product, which has a lateral dimension when aligned in a row. The apparatus 10 includes a row former, generally indicated at 13 and a pattern former generally indicated at 14. The row former forms rows of, for example, tomato slices 16, which are delivered onto a receiving surface, formed by the belt of a conveyor 17. The conveyor 17 is driven intermittently to deliver slices 16 in their row 15 onto the first conveyor 18 of the pattern former 14. The row former 13 includes an inclined conveyor belt 31, which has slats 32 spaced along its length, the spacing being dictated by the lateral dimension of the sliced product to be handled. A series of wiper blades 33 are spaced along the conveyor 31, along the direction of travel. As the belt 31 is driven intermittently the slices are elevated and wiped into the spaces between the slats until rows are formed.

This invention relates to apparatus for forming a row of sliced product, which has a lateral dimension when aligned in a row.

There are many occasions in production processes, when it is desirable to form product into a row and many solutions have been found, depending on the physical characteristics of the product concerned. However, to date, there is no satisfactory system for forming a row of thin products, which have wet or greasy surfaces, which tend to, therefore, be stuck together or to parts of the handling apparatus, by adhesion or surface tension. The operation becomes even more difficult, if the thin product is readily damaged by compression on one of its main faces.

This has particular implications for the food handling industry, where there is a significant need for an ability to deliver such items as sliced tomatoes, sliced cucumber and longitudinally sliced English style sausages onto slices of bread, pizza bases or the like. Although large parts of, for example, a pizza production line are not automated, the application of such items to the base is still done by hand and is very labour intensive. Further, due to the speed required and the sheer tedium of the job, accurate placement is commonly not achieved.

Different embodiments of the invention described below remove or mitigate at least some of the problems identified above.

Thus, from one aspect, the invention consists in apparatus for forming a row of sliced product, having a maximum lateral dimension (as hereinafter defined) when aligned in a row, including a reservoir for the product, an inclined slatted conveyor extending through the reservoir to elevate the product onto a receiving surface characterised in that the slats are spaced by a distance which is between 95% to 105% of the maximum lateral dimension, in that the height of the slats is approximately equal to the thickness of the slices and in that there is a plurality of wiping means or wipers spaced along the conveyer for displacing slices, which do not lie between the slats.

The references to lateral dimension, will depend on the type of product being handled. If the product is man made, the lateral dimension may be fairly constant, but if it is a grown food product, such as a cucumber or tomato, then there will be a variation in the lateral dimension between slices coming from any particular single tomato or cucumber and some variation between tomatoes and cucumbers, although usually they will have been pre-sorted to lie within particular size ranges. For the purposes of this specification the maximum lateral dimension is the maximum lateral dimension of the largest anticipated slide; the combination of the slats spacing and slat height being selected so that only a single slice can be accommodated longitudinally, in the direction of travel of the conveyer, between the slats and so a row of single slices can be assembled between any pair of slats. For general circular slices such as tomatoes or cucumbers the lateral dimension corresponds to the diameter, for elongate objects, such as longitudinally sliced sausages, it is the width.

The Applicants have discovered that by inclining the conveyer, which passes through the product reservoir, for example by forming one wall thereof, they can entrain bulk sliced material. Some will simply drop flat onto the conveyor between the slats, which is the desired position, but other product will lie on the top of the slats or on other slices properly deposited in the row. The inclination of the conveyor tends to make these misplaced slices want to fall back towards the reservoir under gravity and they can therefore relatively easily be displaced by the succession of wiping means as the conveyor passes the wiping means taking the product towards the receiving surface. Experiments have shown that it is possible to achieve a situation where almost no misplaced slices reach the receiving surface. Further, surprisingly, since the main separation of slices is effected by a shear force applied by the slats is in the strong plane of the slice and little or no compressive force is applied to the relatively delicate faces of the slices, they remain substantially undamaged.

Thus, in a preferred embodiment, there are between two and five wiping means or wipers and it is particular preferred that,there should be five wiping means or wipers. For many products the wiping means or wipers are preferably in the form of flexible blades extending laterally across the conveyors, but for other products, such as longitudinally sliced sausage, the wiping means or wipers may include at least one rigid pin and preferably they further include a transport for sweeping the pin across the conveyor. The pin maybe either moved back and forth or, particularly when there is more than one pin, it may be swept continuously in the same direction and passed back around under the conveyor.

It is preferred that the conveyor is inclined at an angle in the range 45° to 60° and it is particularly preferred that the angle of inclination is determined by the product such that, for example, for:

(a) sliced tomatoes the angle of inclination is in the range of 45° to 55°.

(b) sliced cucumber the angle of inclination is in the range of 50° to 60°.

(c) sliced sausages the angle of inclination is between 45° and 55°.

Conveniently the angle of inclination of the conveyor is adjustable so as to achieve the preferred range of angles, but if a single angle is to be selected, then an angle of inclination of 52.5° is particularly preferred.

At least some of the surfaces of the reservoir may be roughened or locally raised to reduce surface tension between those surfaces and the sliced product. The conveyor may include a belt for bearing the product and the belt may have a low co-efficient to friction.

It is particularly preferred that the conveyor is driven discontinuously and even jerkily, because this will assist in the separation of the slices as they are taken from the reservoir and in the displacement of slices which are initially misplaced.

Thus the conveyor may be driven in steps approximately equal to the separation of the slats.

The first wiper blade in the direction of motion of the conveyor may be further away from the conveyor than is the last wiper blade, because initially there is a greater likelihood of product lying on top of the slats and this will reduce damage to the product.

The blades intermediate the first and last may be successively, in the direction of motion of the conveyor, closer to the conveyor or, as in the described embodiment, they may all have the same separation from the conveyor.

The apparatus may further include the receiving surface and an abutment overlying the receiving surface and facing the downstream end of the conveyor for correcting any misalignment in the row as the conveyor deposits a row onto the receiving surface. The previously mentioned intermittent drive helps the conveyor to throw the formed row onto the receiving surface and avoid any product being taken around the back of the conveyor. The receiving surface may be itself a conveyor, such as a belt conveyor and the abutment may extend at an angle to the direction of travel of the receiving surface.

The many advantages of forming product into a row will become more clear below, but it will be appreciated that once a sliced product is formed into a row, it becomes possible to obtain specific position information for any given slice in the row and hence it become possible to contemplate positioning that size in a particular position on a particular substrate, such as a slice of bread or a pizza base. Where a plurality of slices are to be positioned on any substrate, it is convenient to achieve this by pre-forming a pattern of slices ready for such deposition.

Accordingly, from another aspect, the invention includes apparatus for forming patterns of sliced product from a row thereof, including a first conveyor for delivering a row of sliced product to a first transfer point; a second conveyor for receiving slices at the first transfer point and conveying the slices generally in the same direction as the first conveyor to a second transfer point characterised in that the second conveyor is intermittently driveable and the first and second conveyors are laterally displaceable relative to one an other to allow slices to be located on the second conveyor at predetermined laterally and longitudinally displaced positions.

Conveniently, the second conveyor could consist of a pair of adjacent, parallel conveyors each separately controlled to permit slice transfer first to one of the pair, then, after lateral movement, to the second of the pair such that patterns of adjacent slices may be assembled on the conveyor pair.

The second conveyor may further have a position which may be a further lateral position, in which a slice delivered to the transfer point will fall past the conveyor to be rejected. Alternatively slices may be rejected by tilting the downstream end of the first conveyor down or the upstream end of the second conveyor up, then advancing the first conveyor so that the slice falls past the transfer point.

Preferably the apparatus includes a detector for detecting the location of a slice in the row and a controller for controlling the operation of the first and second conveyors in accordance with the detected position or the detected absence of a product from a row location.

Thus if a gap in the row is detected, the first conveyor will be advanced until the next slice reaches the first transfer point and, during that period, the second conveyor will not move.

Although the detection could take place adjacent to the transfer point, it is preferred that it takes place significantly upstream, to allow appropriate control time.

The apparatus may further include a visual recognition device for assessing whether or not a product should be rejected and wherein the controller controls the operation of the second conveyor in response to the visual recognition device. Preferably the visual recognition device constitutes the detector. A typical reject would be the end slice of a tomato or a cucumber.

The apparatus may further include a third conveyor for receiving a pattern of slices at the second transfer point and for delivering the pattern to a substrate location. Conveniently the third conveyor is downwardly inclined with respect of the second conveyor so that the substrate location can lie beneath the apparatus, for example on a substrate conveyor passing below. The third conveyor may, initially, accelerate each pattern away from the second transfer point, so as to separate uniquely the pattern.

The apparatus may further include a further detector for detecting the approach of a substrate to the substrate location, in which case the controller may operate the apparatus in response to that detection step.

By using the substrate as the control element for the timing of the machine, one can ensure that the patterns are delivered at the appropriate moment, whatever has been the accuracy of the substrate placement on the substrate conveyor.

It will readily be understood that the apparatus for forming a row and the apparatus for forming a pattern may be combined into a single apparatus for delivering a pattern of slices to a substrate. In this case the receiving surface is positioned upstream of the aforementioned first conveyor and preferably the detector is located above the receiving surface. It is envisaged that the receiving surface conveyor will be driven intermittently to deposit product, one row at a time or a plurality of slices, onto the first conveyor.

This apparatus can be configured as a free standing apparatus, which can be positioned relative to the main production line, including the substrate conveyor as and when required. In this case the receiving surface and first, second and third conveyors will be preferably supported in a cantilever manner.

From another aspect the invention consists in apparatus for delivering a pattern of product to a substrate, travelling on a substrate conveyor, at a substrate location including a detector for detecting the approach of a substrate to the substrate location and a controller for controlling the operation of the apparatus in dependence on the substrate detection. As has previously been mentioned the substrate may be a bread slice or a pizza base, and the product may be sliced cucumber, tomato or sausage.

Although the invention has been defined above it is to be understood it includes any inventive combination of the features set out above or in the following description. The invention may be performed in various ways and specific embodiments will now be described with reference to the accompanying drawings, in which:

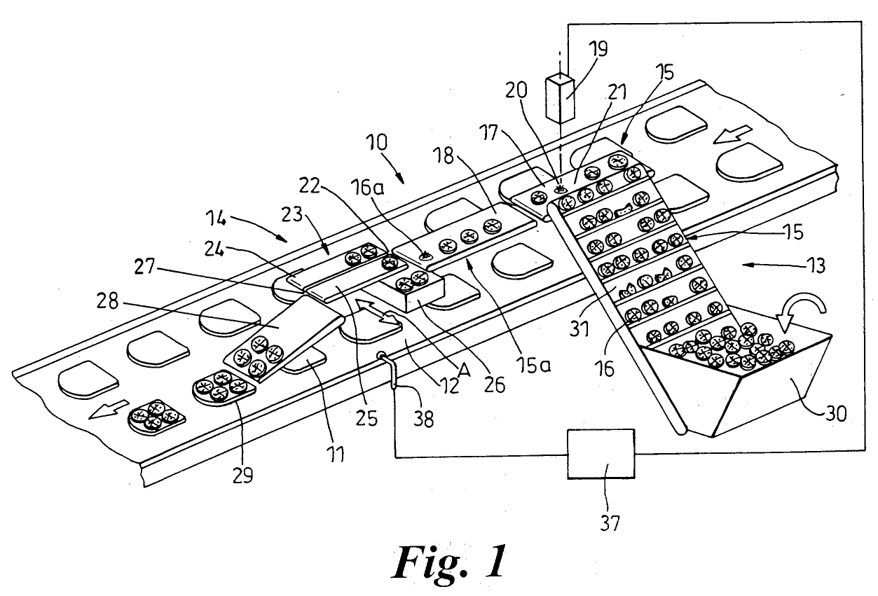

FIG. 1 is a schematic layout of apparatus for forming a row of sliced material in combination with apparatus for forming a pattern of that sliced material from the pre-formed row and for delivering that pattern onto a slice of bread;

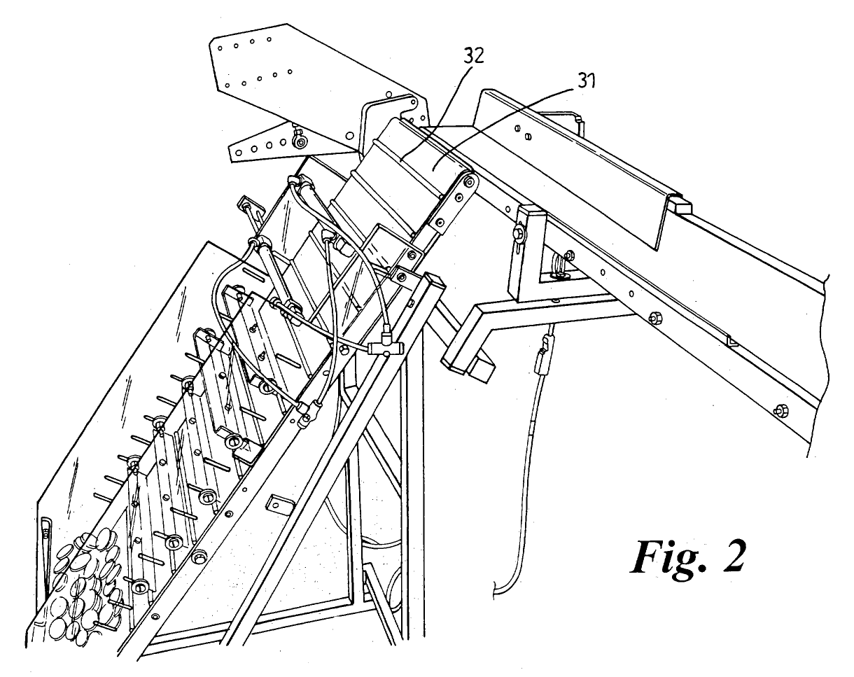

FIG. 2 is a photograph of a side view of a prototype of the row forming apparatus;

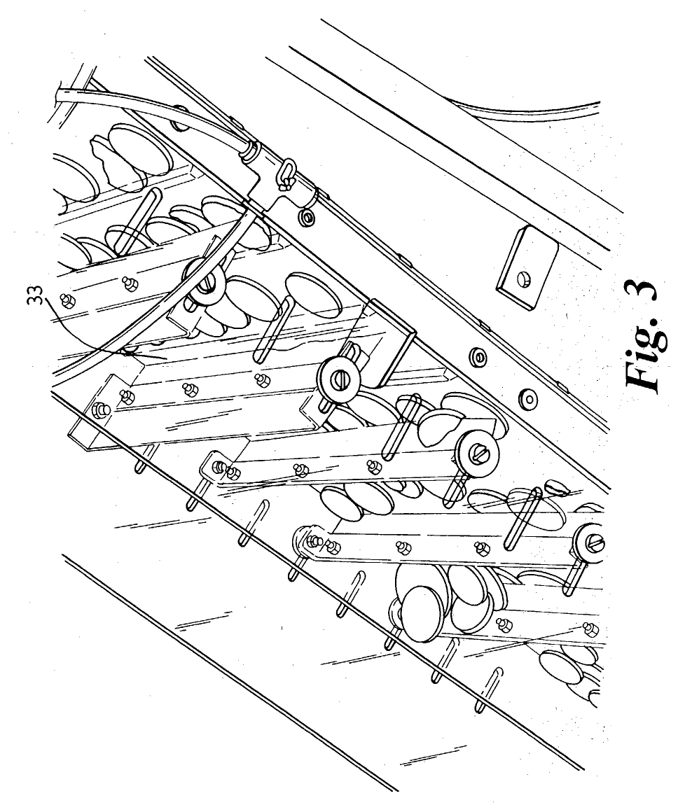

FIG. 3 is an enlarged view of the apparatus of FIG. 2 at a later stage in the row forming;

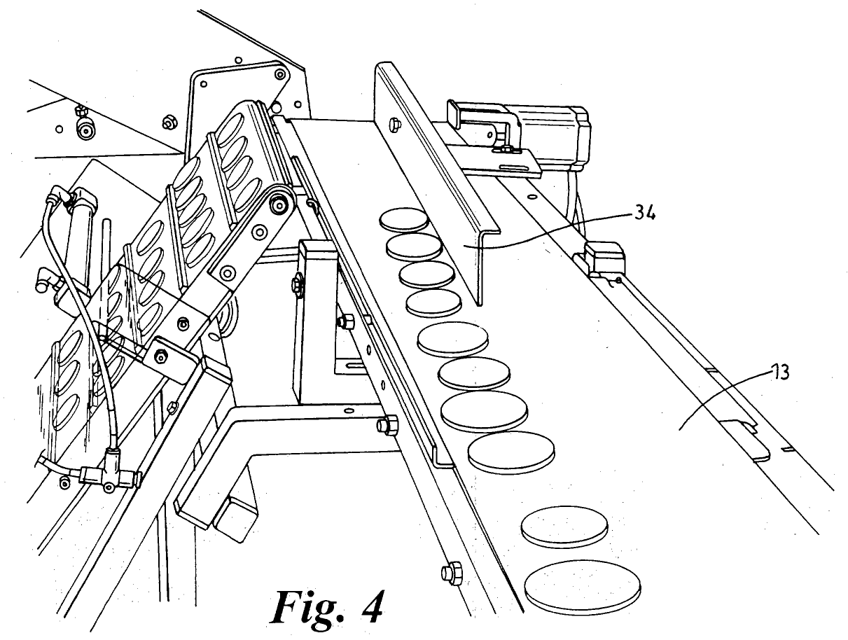

FIG. 4 is a detailed view of the delivery end and receiving surface of the apparatus of FIG. 2;

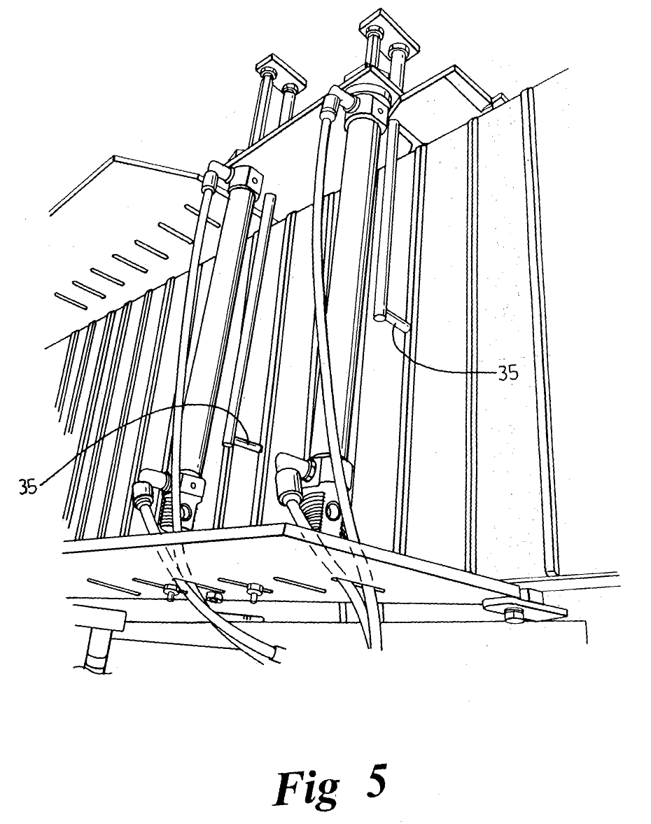

FIG. 5 is a view from the upper end and above of an adaptation of the apparatus of FIG. 3 for use with sliced sausage;

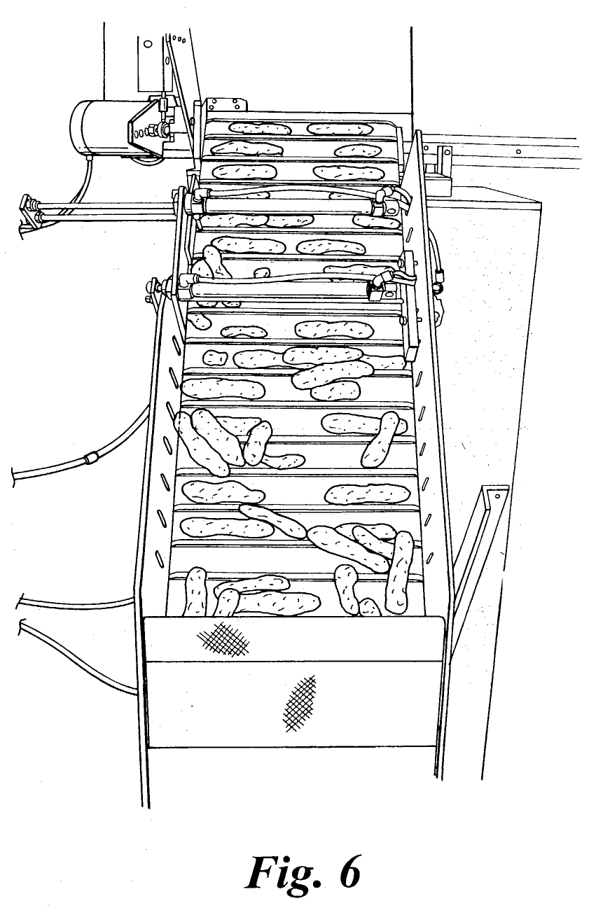

FIG. 6 is a front view of the apparatus of FIG. 5 with the forming of rows of sausage being demonstrated;

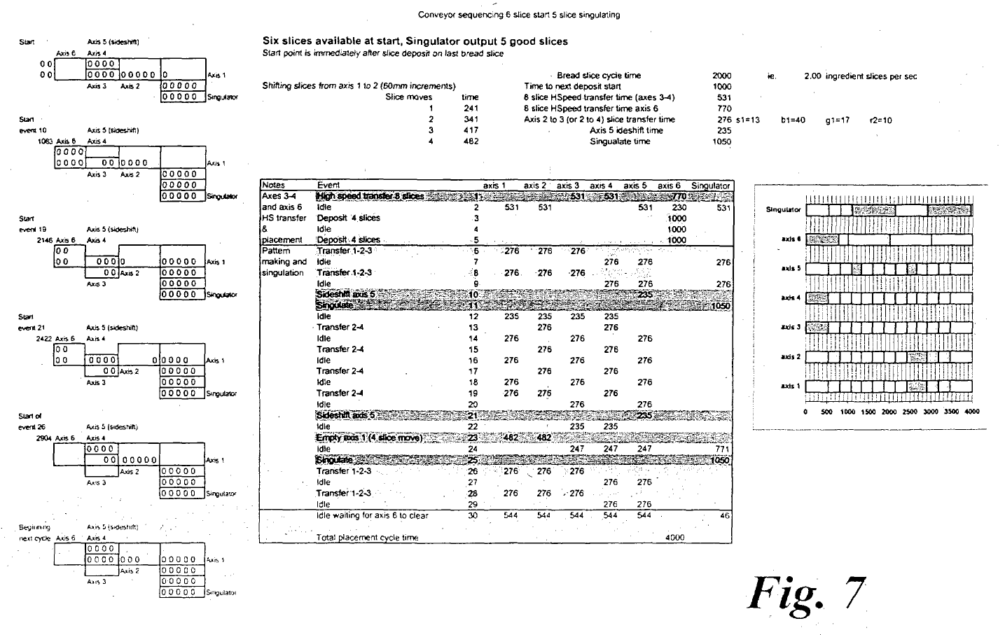

FIG. 7 is a graphical representation of pattern forming and typical sequencing using the apparatus illustrated in FIG. 1;

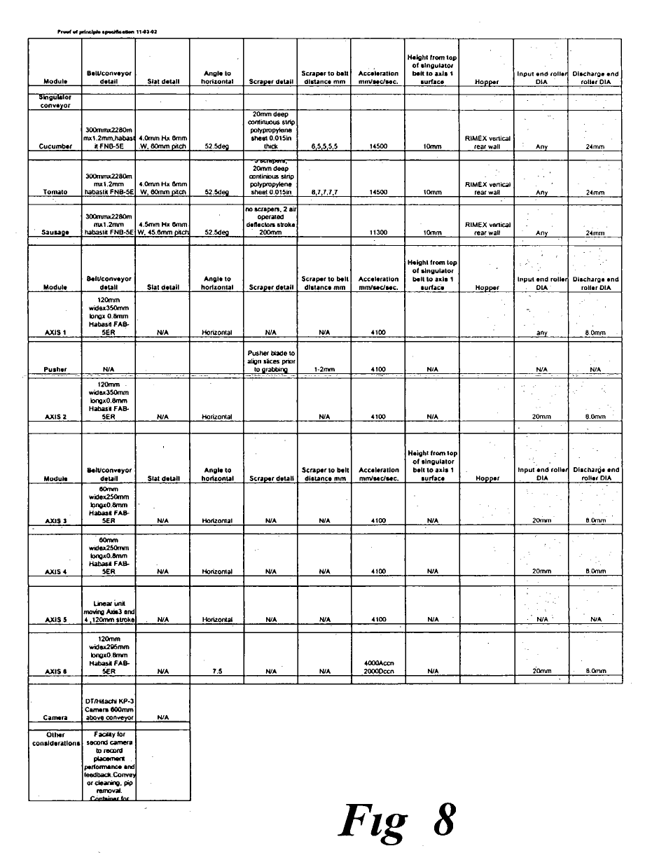

FIG. 8 is a detailed tabulation of dimensions and performance characteristics of different aspects of the apparatus of FIG. 1;

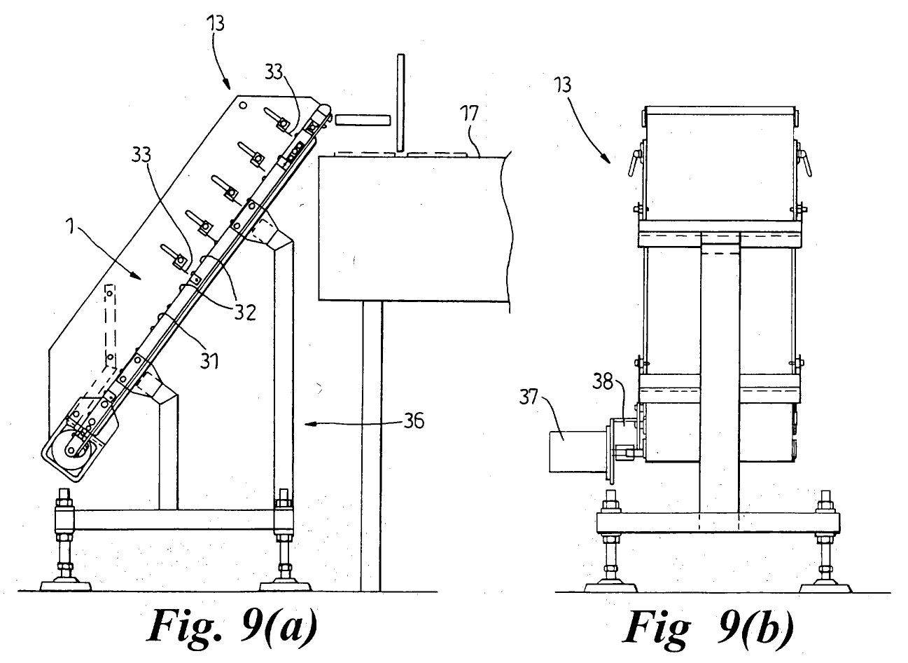

FIGS. 9(a) and (b) are respective side and rear views of a practical construction of a singulator with some of the hopper missing;

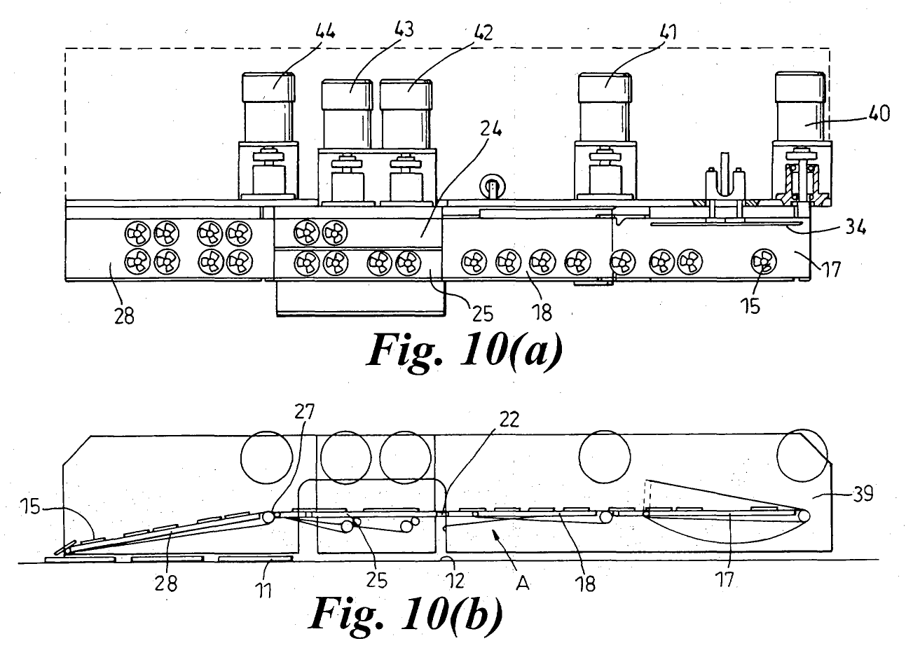

FIGS. 10(a) and (b) are respective plan and side views of an alternative form of pattern former; and

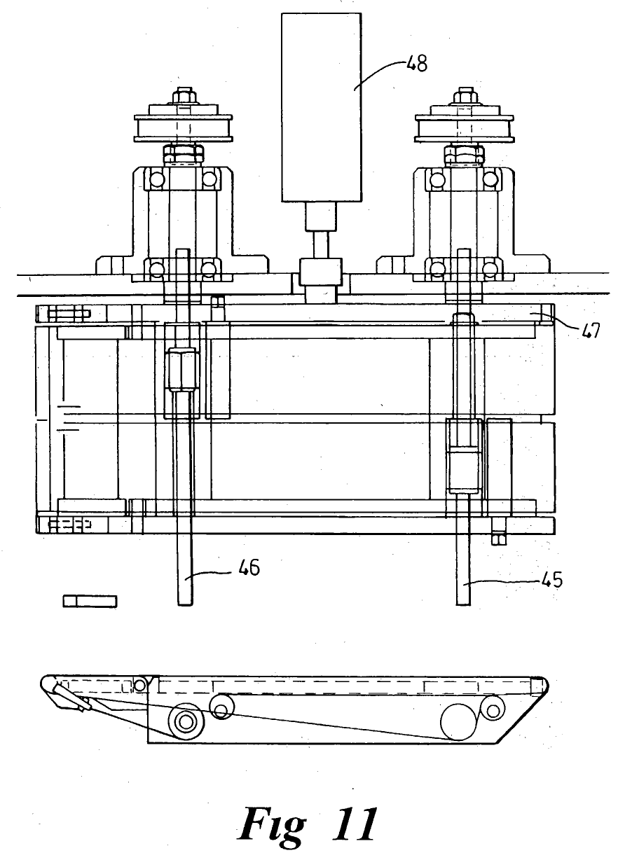

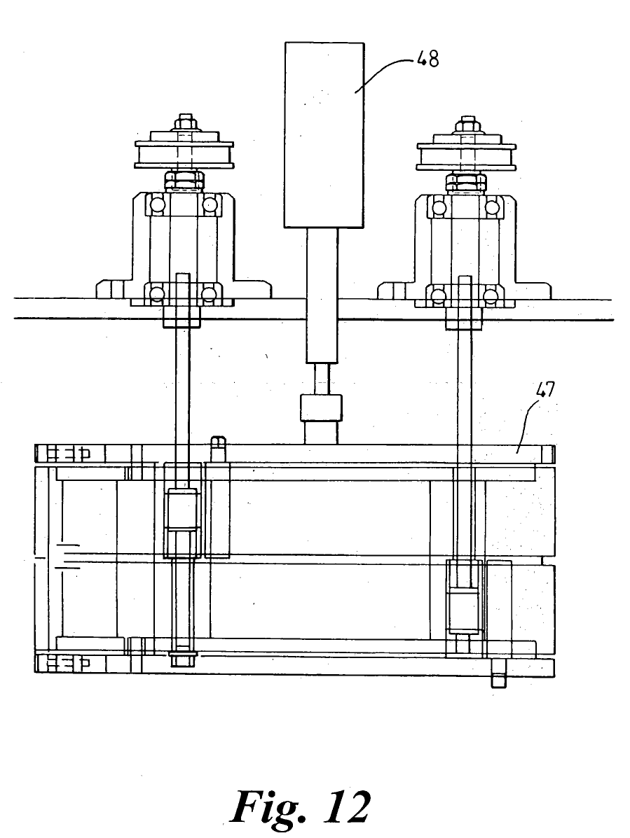

FIGS. 11 and 12 are detailed views of the laterally movable conveyor of FIG. 10 in respective lateral positions.

FIG. 1 illustrates, schematically, apparatus, generally indicated at 10, for depositing patterns of tomatoes onto slices 11 of bread travelling on a conveyor 12. The apparatus includes a row former or singulator, generally indicated at 13 and a pattern former generally indicated at 14.

The row former 13 will be described in much more detail below, but in general it will be noted that it forms rows 15 of tomato slices 16 which are delivered onto a receiving surface, formed by the belt of a conveyor 17. The conveyor 17 is driven intermittently to deliver slices 16 in their row 15 onto the first conveyor 18 of the pattern former 14. After the row 15 has been deposited onto conveyor 17, each slice 16 passes under a visual recognition detector 19. The visual recognition detector 19 carries out a number of functions:

1. It detects the precise position of each slice 15 in the row.

2. It detects the absence of a slice in the row, because, for reasons which will be described below, not every row will be complete.

3. It detects slices which are to be rejected either because they are severely damaged or, for example, as shown at 20, they are the end slice of a tomato. A gap is indicated at 21.

This information is used to control the transfer operation of the conveyor 17 as it feeds the members of the row 15a onto conveyor 18. These members of the row 15a are fed towards a transfer point 22 adjacently upstream end of the second conveyor 23 of the pattern former 14.

As can be seen in FIG. 1 the conveyor 23 has two side-by-side belts 24, 25 that can be driven either individually or together. These belts 24, 25 are laterally moveable, as indicated by the arrow A so that one or other can be aligned, at the transfer point 22, to receive a slice 16 from the conveyor 18. They can also take up the position, illustrated in FIG. 3, where the slice will fall past the side of the conveyor 25 into a reject container 26. It will be noted, in FIG. 1, that the lead slice 16a on the conveyor 18 happens to be an end slice of a tomato, which has been detected by the detector 19 and this detection has been used to cause the illustrated positioning of the conveyor 23.

In more normal use, the conveyor 23, will be aligned with the row 15 on the conveyor 18 initially, to receive two slices 16 and then the conveyor 25 will be aligned to receive its two slices so that a pattern of four is formed.

Both conveyors 24, 25 then advance together and a further pattern of four is formed as before. The advancement of the belts 24, 25 drive the pattern of four towards a second transfer point 27, which is at the upstream end of a delivery conveyor 28. This receives the pattern and accelerates it away from the transport point 27, initially, and then decelerates to deliver the pattern of four onto the slice of bread 11 which has arrived at the deposition location 29, as illustrated. The conveyor 28 is downwardly inclined as indicated.

A test sequence for the above described operation is tabulated on FIG. 8 and this gives an example of the timing of various parts of the operation.

The precise method of controlling the various conveyors and the actual physical structure of the conveyors are all matters which would be well understood by a person skilled in the art. However, it should be appreciated that when product is being transferred from one belt to the other, once the product has been delivered onto the receiving conveyor 17, the belts must be at the same speed through the transfer. Subsequent acceleration may be used to assist in the creation of patterns of gaps or to take in to account the presence of a gap in a row. If a gap is needed between patterns or within patterns, the downstream belt may be started earlier; if there is an upstream gap, then the upstream belt may be started first.

Rejection may alternatively take place by simply tilting the second conveyor 23 so that the rejected slice passes beneath its upstream end. It is thought that this may provide more efficient mode of operation.

In the above description it has been suggested that the detector 19 works on the basis of detecting slices as they pass beneath it. More simply it may compare the whole row 15 when it is delivered onto the receiving conveyor 17 and more sophisticated systems can be introduced to give precise X,Y co-ordinates for each slice. This could become particularly necessary if more complex patterns are to be introduced, for example the formation of a circular pattern may be desirable for pizzas.

The belt of the conveyor 28 preferably has a surface which provides good adhesion, so that the pattern is maintained.

In FIG. 1 the row former or singulator 13 includes a hopper 30 for receiving the sliced product. One wall of the hopper 30 is formed by an inclined slatted conveyor 31. The operation of the singulator 13 will be described in more detail with reference to FIGS. 2 to 4, but it should be understood that these are photographs of a prototype arrangement in which the true hopper is absent, instead, conveniently, the product is held in the end of a transparent cover.

Referring now to FIGS. 2 to 4, the singulator 13 includes an inclined conveyor belt 31 which has transfer slats 32 spaced along its length. The spacing of the transfer slats 32 is dictated by the lateral dimension of the sliced product to be handled and it should be great enough to accommodate the largest of the expected slices 16, but not so large as to allow more than one slice to glide between any pair of slats 32. The height of the slats 32 is approximately equal to the thickness of the slices to be handled and so when one slice sits on the top of another, the upper slice will not lie between the slats 32.

A series of wiper blades 33 (these can be best seen in FIG. 3) are spaced above the conveyor 31 along the direction of travel. The wiper blades are preferably spaced by less than the thickness of the slices from the tops of the slats 32, and, conveniently, the most downstream blade 33, can be slightly more spaced. Typical scraper to belt distances are given in the table constituting FIG. 9.

In use, as has been explained already, the belt 31 is driven intermittently and is preferably advanced by the spacing between the slats. The movement of the slats through the product in the hopper 30, tends to cause product to become entrained on the conveyor belt 31 and it will begin to be elevated.

Initially, as is well shown in FIG. 3, some of the slices fall immediately between the slats but others become piled up on each other, lie on top of slices within the slats or lie on top of the slats themselves. The most unstable of these fall back towards the hopper under gravity, but some will be retained initially in misplaced positions, for example by surface tension between slices. As this misplaced product is brought against successive wiper blades, it is pushed rearwardly either to fall back into the hopper, when it engages the first blade or it is pushed into a vacant row position between a pair of slats 32. It has been discovered that if there are five blades, it is most unusual for any misplaced slice to pass the last blade in the array.

It will be appreciated that the performance of particular blades in any arrangement will depend on such matters as conveyor speed, conveyor angle, flexibility of blade, the nature of the product and so on. These will be a matter for simple experiment, but it is envisaged that at least a reasonable degree of row forming will be achieved even with two blades.

As can be see in FIG. 4, by the time the blades have been passed, a series of rows 15 are formed.

When a row 15 reaches the top of the conveyor 31, the next intermittent drive will throw the row onto the receiving surface conveyor 17. Preferably, as illustrated in FIG. 4, there is an abutment wall 34 located opposite the end of the conveyor 31 so that as the slices 15 are thrown onto the conveyor 17 their edges strike the wall 34 and realignment of the row 15 takes place. The abutment wall 34 may be inclined, in the direction of travel of the conveyor 17 so that the row is moved towards one part of the conveyor, in this case the edge, so as to enhance the positioning of the row relative to the detector system. Alternatively the wall 34 may be generally parallel to the conveyor 17, but arranged to be movable towards the singulator to push the slices into alignment before returning to its rest position to await the next set of slices 15.

FIGS. 6 and 7 illustrate the identical apparatus for use with sliced sausages, except here the wiping blades have been replaced by rigid pins 35 which are mounted to be swept back and forth across the conveyor 31 by pneumatic cylinders 36. It has been found that this method of displacement is more applicable for oblong objects such as sausage slices.

Otherwise the operation is the same and the sausage slices can equally be handled by the downstream reject and patterning system as described in FIG. 1.

The conveyors 17, 18, 23 and 28 and singulator 13 may be controlled by a controller 37 which is responsive to the detector 19 and to a slice of bread detector 38. The latter is positioned upstream of the location 29 and can be used to give the timing for the entire assembly so that each element operates so that the pattern arrives at the location just in time. By using the slice of bread or substrate to operate the row and pattern forming apparatus, the Applicant ensures that patterns are delivered in response to the actual presence of a substrate and not merely in anticipation of such a presence.

FIGS. 9(a) and 9(b) are included to illustrate a practical construction of the singulator and in particular the spacing and mounting of the blades 33. No further description is required, but the supporting frame 36, the stepper motor 37 and drive 38 will be noted.

Turning to FIGS. 10(a) and 10(b) a slightly different construction of the pattern former 14 is illustrated. Common elements of the pattern former have the same numbering as in the previous figures.

The function of this alternative embodiment is substantially the same as in the previous construction and only differences will be noted. Thus, rather than being cantilevered over the conveyor 12, it is mounted alongside the conveyor 12 on a side wall 39, which also acts as the support for drive motors 40 to 40 44 for the respective conveyors. This construction has been found to be mechanically particularly satisfactory. Also mounted on the side wall 39 is the guide wall 34, which is pneumatically movable towards and away from the wall 39.

As schematically indicated at A in FIG. 10(b) the nose of conveyor 18 can dip to perform the ejection function.

Turning now to FIGS. 11 and 12, the mounting of the laterally movable conveyors 24 and 25 is shown in more detail. As can be seen drive motors 42 and 43 have respective drive shafts 44, 45, each of which is splined along at least part of its length. The shafts 44 and 45 extend horizontally above the conveyor 11 and act as mountings for the lateral movement of the conveyors, as described above. The drive pulley, 46, 47 for the respective conveyors 24, 25 have corresponding spline formations for engaging on the shafts 44 and 45 respectively so that they can be driven by their shaft, but simply slide on the other shaft.

The conveyors 24, 25 are mounted on a common frame 47, which is movable, between the lateral positions indicated in FIGS. 11 and 12 respectively, by a pneumatic piston 48.

1. Apparatus for forming a row of sliced product having a maximum lateral dimension (as hereinbefore defined) when aligned in a row including a reservoir for the product, an inclined slatted conveyor extending through the reservoir to elevate the product on to a receiving surface characterised in that the slats are spaced by a distance which is 95%-105% of the maximum lateral dimension and in that the height of the slats is approximately equal to the thickness of the slices and in that there is a plurality of wiping means or wipers spaced along the conveyor for displacing slices, which do not lie between the slats.

2. Apparatus as claimed in claim 1 wherein there are between two and five wiping means or wipers.

3. Apparatus as claimed in claims 1 or 2 wherein there are five wiping means or wipers.

4. Apparatus as claimed in any one of claims 1 to 3 wherein the wiping means, or wipers are in the form of flexible blades extending laterally across the conveyor.

5. Apparatus as claimed in any one of claims 1 to 3 wherein the wiping means or wipers include at least one rigid pin.

6. Apparatus as claimed in claim 5 including the wiping means or wipers including a transport for sweeping the pin across the conveyor.

7. Apparatus as claimed in any one of the preceding claims wherein the conveyor is inclined at an angle in the range 45°-60°.

8. Apparatus as claimed in claim 7 wherein the angle of inclination is determined by the product such that for:
(a) sliced tomatoes the angle of inclination is in the range 45°-55°.
(b) sliced cucumber the angle of inclination is in the range 50°-60°.
(c) sliced sausages the angle of inclination is between 45°-55°.

9. Apparatus as claimed in claim 7 wherein the angle of inclination is 52.5°.

10. Apparatus as claimed in any one of the preceding claims wherein at least some of the surfaces of the reservoir are roughened or locally raised to reduce surface tension.

11. Apparatus as claimed in any one of the preceding claims wherein the conveyor includes a belt for bearing the product and has a low coefficient of friction.

12. Apparatus as claimed in any one of the preceding claims wherein the conveyor is driven discontinuously or jerkily.

13. Apparatus as claimed in claim 12 wherein the conveyor is driven in steps approximately equal to the separation of the slats.

14. Apparatus as claimed in claim 12 wherein the conveyor is driven jerkily.

15. Apparatus as claimed in claim 4 wherein the first wiper blade in the direction of motion of the conveyor is further away from the conveyor than is the last wiper blade.

16. Apparatus as claimed in claim 15 wherein the blades intermediate the first and the last are successively in the direction of motion of the conveyor, closer to the conveyor.

17. Apparatus as claimed in any one of the preceding claims further including the receiving surface and an abutment overlying the receiving surface and facing the downstream end of the conveyor for correcting any misalignment in the row.

18. Apparatus as claimed in claim 17 wherein the abutment is moveable towards or away from the conveyor to push the slices into alignment.

19. Apparatus as claimed in claim 17 or 18 wherein the receiving surface is a further conveyor.

20. Apparatus as claimed in any one of claims 17 to 19 wherein in the abutment extends at an angle to the direction of travel of the receiving surface.

21. Apparatus for forming patterns of sliced product from a row thereof including a first conveyor for delivery a row of sliced product to a first transfer point; a second conveyor for receiving slices at the first transfer point and conveying the slices generally in the same direction as the first conveyor to a second transfer point characterised in that the second conveyor is intermittently driveable and laterally displaceable relative to the first conveyor to allow slices to be located thereon at predetermined laterally and longitudinally displaced positions.

22. Apparatus as claimed in claim 21 wherein the second conveyor is itself formed from a plurality of parallel adjacent conveyors, each separately controllable.

23. Apparatus as claimed in claim 22 wherein the adjacent conveyors are mounted on a plurality parallel, independently drivable spline drives for ‘lateral’ movement along the drives, there being one drive for each conveyor and each conveyor only being drivingly engaged to its respective drive.

24. Apparatus, as claimed in any one of claims 21 to 33 wherein the first or second conveyor has a lateral position in which a slice delivered to the transfer point will fall past that conveyor to be rejected.

25. Apparatus as claimed in any one of claims 21 to 24 further including a detector for detecting the location of a product in the row and a controller for controlling the operation of the first and second conveyors in accordance with the detected position or the detected absence of product from a row location.

26. Apparatus as claimed in claim 25 further including a visual recognition device for assessing whether or not a product should be rejected and wherein the controller controls operation of the first or second conveyor in response to the visual recognition device.

27. Apparatus as claimed in claim 26 wherein the visual recognition device constitutes the detector.

28. Apparatus as claimed in any one of claims 21 to 27 further including a third conveyor for receiving patterned product at the second transfer point and for delivering the pattern to a substrate location.

29. Apparatus as claimed in claim 28 wherein the third conveyor is downwardly inclined with respect to the second conveyor.

30. Apparatus as claimed in claims 28 or 29 wherein the third conveyor initial accelerates each pattern away from the second transfer point.

31. Apparatus as claimed in any one of the claims 28 to 30 the first, second and third conveyors are disposable above a substrate conveyor for delivering substrates to the substrate location.

32. Apparatus as claimed in any one of claims 28 to 31 further including a further detector for detecting the approach of a substrate to the substrate location and wherein the controller operates the apparatus in response to that detection step.

33. Apparatus for delivering a pattern of product to a substrate including apparatus for forming a row as claimed in any one of claims 1 to 20 and apparatus for forming a pattern as claimed in any one of claims 21 to 32.

34. Apparatus as claimed in claim 33 wherein the apparatus is free standing.

35. Apparatus for delivering a pattern of product to a substrate, travelling on a substrate conveyor, at a substrate location including a detector for detecting the approach of a substrate to the substrate location and a controller for controlling the operation of the apparatus in dependence on the substrate detection.

36. Apparatus as claimed in any one of claims 33 to 35 wherein the substrate is a bread slice or a pizza base.

37. Apparatus as claimed in any one of the preceding claims other than claims 5 or 6 or claims dependent thereon wherein the product is cucumber or tomato.

38. Apparatus as claimed in claim 5 or claim 6 or claims dependent thereon wherein the product is sausage.

39. An assembly of independently drivable laterally movable adjacent conveyors, wherein the conveyors are mounted on a plurality of parallel, independently drivable spline drives for ‘lateral’ movement along the drives, there being one drive for each conveyor and each conveyor only being drivingly engaged to its respective drive.
